(19) United States
(12) Patent Application Publication
(10) Pub. No.: US 2013/0254172 A1
(43) Pub. Date: Sep. 26, 2013

(54) INFORMATION PROVISION SERVER, INFORMATION PROVISION SYSTEM, INFORMATION PROVISION METHOD AND PROGRAM

(71) Applicant: Masafumi Watanabe, Tokyo (JP)

(72) Inventor: Masafumi Watanabe, Tokyo (JP)

(73) Assignee: NEC CORPORATION, Minato-ku, Tokyo (JP)

(21) Appl. No.: 13/876,536

(22) PCT Filed: Sep. 20, 2011
(86) PCT No.: PCT/JP2011/071363

§ 371 Date: Jun. 12, 2013

(30) Foreign Application Priority Data
Oct. 1, 2010 (JP) 2010-224290

(51) Int. Cl. G06F 21/62

(52) U.S. Cl. CPC G06F 21/6227
USPC 707/694

(57) ABSTRACT

The present invention provides an information provision server comprising: a history information storage which stores, as history information, a user identifier and history element information received from a user terminal; a rule storage which stores a rule that authorizes the stored user history information to be output to a service server that provides a service to the terminal; a rule assessment unit which receives the user identifier and assessment element information from the terminal, assesses the assessment element information on the basis of the rule, and, if the assessment element information conforms to the rule, enters the user identifier corresponding to the assessment element information into an output authorization list; and a filtering unit which extracts from the history information storage, the history information corresponding to the user identifier entered into the output authorization list, and outputs the extracted history information to the service server.

### TECHNICAL FIELD

The present invention relates to an information provision server, an information provision system, an information provision method and a program therefor.

### BACKGROUND ART

A scheme of skillfully guiding, by providing area information including advertisements etc. to a person visiting a town, the above person to shops etc., extending his/her staying time in the town, and revitalizing an entirety of the town is being investigated. For example, an area revitalization system for promoting a user's goods purchase and service usage in shops of the area, and revitalizing area economy by extracting area information within a user's home range from information database, editing it and transmitting it to user terminals is described in Patent literature 1.

Further, it is also being investigated to collect/accumulate history information such as a visitor's travel route by utilizing GPS (Global Positioning Systems) etc., and provide the area information that matches with visitor's needs all the more by utilizing the history information. For example, in an advertisement provision system of Patent literature 2, when a terminal device detects an electromagnetic wave beacon that access point devices of a wireless LAN arranged all over town emit, accumulates a history of SSID, and transmits the above history to a server device at a predetermined timing, the server device transmits to the terminal device advertisement information caused to correspond to the SSID included in the above history.

In addition, the invention that takes into consideration a management of the area information taking into consideration an improvement in an efficiency of space browse and a plurality of services when defining a plurality of different information provision areas at an identical position in a case of providing information corresponding to a designated position is also proposed. For example, the invention of Patent literature 3 utilizes a multistage index structure based on “R*-tree”, browses the area, being a candidate, at a high speed from respective areas expressed in minimum bounding rectangle (MBR), furthermore specifies the area by utilizing improved quadtree data from browsed area, and provides service and information associated with the specified area on the basis of the information relating to the user and the service provider.

Hereinafter, the above-described area revitalization system and advertisement provision system are referred to as an information provision system.

### CITATION LIST

### Patent Literature

PTL 1: JP-P2006-059166A
PTL 2: JP-P2009-188922A
PTL 3: International Publication: WO2006 059629

### SUMMARY OF INVENTION

### Technical Problem

Utilizing the above-described information provision system, and carrying out, when a visitor is present in a certain area, the guidance into the shops in the above area, and, for example, the provision of the area information matching with needs of the visitor based on the history information of the visitor collected in the above area makes it possible to expect an effect of the area vitalization.

However, even though, when the visitor is not already present in the above area, the guidance into the shops in the above area is carried out based on the history information of the visitor collected in the above area, an effect of the area vitalization cannot be expected. On the contrary, when the information relating to the area in which the visitor is not already present is provided, the visitor feels annoyed at it in some cases. That is, there is an effect of the information provision based on the history information of the visitor in some cases, and there is no effect in some cases, dependent upon a situation of the visitor's belonging.

Thereupon, the present invention has been accomplished in consideration of the above-mentioned problems, and an object of the present invention is to provide an information provision server, an information provision system, an information provision method, a program therefor that make it possible to provide the history information to the service server when the service having a high effectiveness can be provided to the user.

### Solution to Problem

The present invention is an information provision server, comprising: a history information accumulation unit that accumulates a user identifier and history element information received from a terminal of a user as history information; a rule storage unit that stores a rule of authorizing an output of the history information of the user accumulated in said history information accumulation unit to a service server that provides a service to said terminal; a rule assessment unit that receives the user identifier and assessment element information from the terminal, assesses said assessment element information based on said rule, and lists the user identifier corresponding to said assessment element information in an output authorization list when said assessment element information meets said rule; and a filtering unit that extracts the history information corresponding to the user identifier listed in said output authorization list from said history information accumulation unit in response to an output request for the history information by said service server, and outputs the extracted history information to said service server.

The present invention is an information provision system, comprising: an information provision server comprising: a history information accumulation unit that accumulates a user identifier and history element information received from a terminal as history information; a rule storage unit that stores a rule of authorizing an output of the history information of a user accumulated in said history information accumulation unit to a service server that provides a service to said terminal; a rule assessment unit that receives the user identifier and assessment element information from said terminal, assesses said assessment element information based on said rule, and lists the user identifier corresponding to said assessment element information in an output authorization list when said assessment element information meets said rule; and a filtering unit that extracts the history information corresponding to the user identifier listed in said output authorization list from said history information accumulation unit in response to an output request for the history information by said service server, and outputs the extracted history information to said service server; a terminal comprising: an acquisition unit that acquires the history element information or the assessment element information of the terminal; and an information transmission unit that transmits information including said user identifier and at least one of the acquired history element information and said assessment element information to said information provision server; and a service server comprising: a history request unit that requests said information provision server to output the history information; and a service provision unit that provides the service to said terminal based on the history information coming from said information provision server.

The present invention is an information provision method, comprising: accumulating a user identifier and history element information received from a terminal of a user as history information; assessing assessment element information received from said terminal based on a rule of authorizing an output of said accumulated history information of the user to a service server that provides a service to said terminal, and updating, in such a manner that the user identifier corresponding to said assessment element information is listed in an output authorization list that authorizes an output of the history information to said service server, said output authorization list when said assessment element information meets said rule; and extracting the history information corresponding to the user identifier listed in said output authorization list from said accumulated history information of the user in response to an output request for the history information by said service server and outputting the extracted history information to said service server.

The present invention is a program for causing an information processing device to execute the processes of: accumulating a user identifier and history element information received from a terminal of a user as history information; assessing assessment element information received from said terminal based on a rule of authorizing an output of said accumulated history information of the user to a service server that provides a service to said terminal, and updating, in such a manner that the user identifier corresponding to said assessment element information is listed in an output authorization list that authorizes an output of the history information to said service server, said output authorization list when said assessment element information meets said rule; and extracting the history information corresponding to the user identifier listed in said output authorization list from said accumulated history information of the user in response to an output request for the history information by said service server and outputting the extracted history information to said service server.

### Advantageous Effect of Invention

The present invention makes it possible to provide the history information to the service server when the service having a high effectiveness can be provided to the user.

### BRIEF DESCRIPTION OF DRAWINGS

FIG. 1 is a configuration view of the exemplary embodiment of the present invention.

FIG. 2 is a configuration view of a first exemplary embodiment.

FIG. 3 is a view illustrating a specific example of user information.

FIG. 4 is a block diagram of a history information server 10.

FIG. 5 is a view illustrating a specific example of the history information accumulated in a history information storage unit 140.

FIG. 6 is a view illustrating a specific example of a rule.

FIG. 7 is a view illustrating one example of an authorization list.

FIG. 8 is a flowchart of an operation at the time when the history information server 10 has received the user information from a user terminal 20.

FIG. 9 is a flowchart of an operation at the time when the history information server 10 has received a request of the history information from a contents server 30.

FIG. 10 is a view illustrating a specific example of the history information.

FIG. 11 is a view illustrating one example of the rule of a second exemplary embodiment.

FIG. 12 is a flowchart of an operation at the time when the history information server 10 has received visit information from the user terminal 20.

FIG. 13 is a flowchart of an operation at the time when the history information server 10 has received position information from the user terminal 20.

FIG. 14 is a view illustrating a specific example of the rule.

FIG. 15 is a flowchart of an operation at the time when the history information server 10 has received the user information including the visit information or acceleration information from the user terminal 20.

FIG. 16 is a flowchart of an operation at the time when the history information server 10 has received the position information from the user terminal 20.

FIG. 17 is a flowchart of an operation at the time when the history information server 10 has received a request of the history information from a contents server 30.

FIG. 18 is a configuration view of example 1.

### DESCRIPTION OF EMBODIMENTS

The exemplary embodiments of the present invention will be explained.

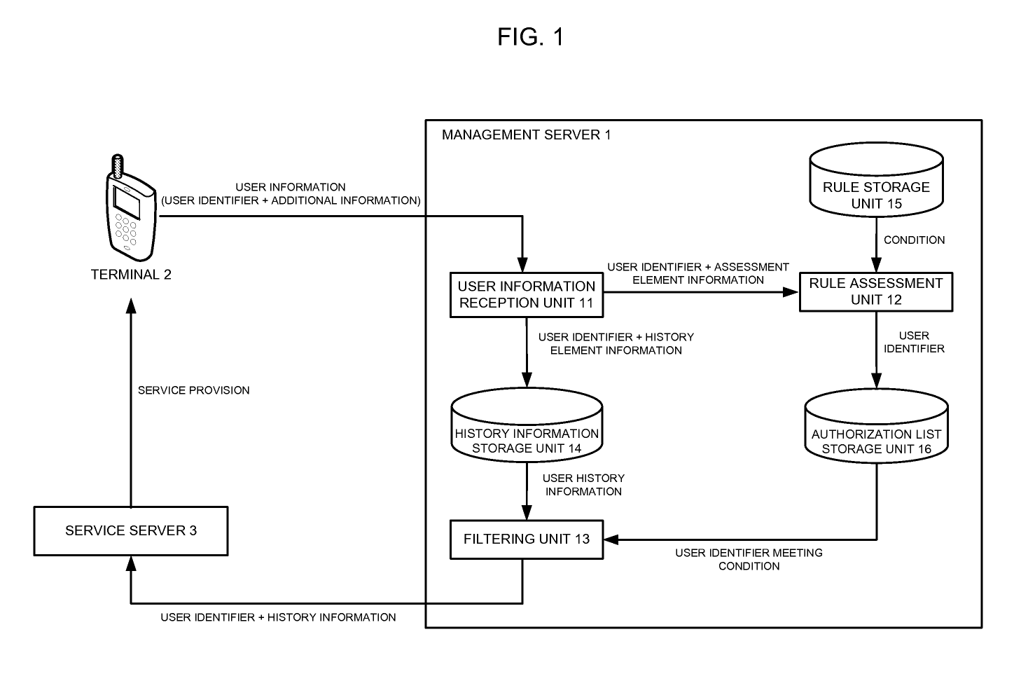

FIG. 1 is a configuration view of the exemplary embodiment of the present invention.

This exemplary embodiment includes a management server 1 that manages a history of the user, a user terminal 2 of the user, and a service server 3 that provides the service to the user or the user terminal 2 of the above user.

Herein, the so-called service is to carry out the provision of the contents such as the area information, the goods information, images, and music, and the change of setting of the user terminal and the like based on the history information of the user or the user terminal 2 of the user.

The user terminal 2 transmits to the management server 1 the user information including at least history element information, being an element of the history information of the user such as the information of the current position, the information of the visit to the shops and the acceleration information, and a user identifier that identifies the user or the user terminal 2. Further, the user terminal 2, as described later, transmits assessment element information as well, being information for assessing whether to authorize an output of the history information of the user to the service server 3, together with the user identifier, apart from the history element information. Additionally, there is not only the case in which the history element information and the assessment element information differ from each other, but also the case in which one piece of information could be the history element information and the assessment element information. In the following explanation, there is a case in which the information including the user identifier, and the history element information or the assessment element information is described as the user information.

The management server 1 includes a user information reception unit 11, a rule assessment unit 12, a filtering unit 13, a history information storage unit 14, a rule storage unit 15, and an authorization list storage unit 16.

The user information reception unit 11 receives the user information from the user terminal 2, and outputs the user identifier and the history element information included in the user information to the history information storage unit 14. Further, the user information reception unit 11 outputs the user identifier and the assessment element information included in the user information to the rule assessment unit 12.

The history information storage unit 14 stores the user identifier received from the user information reception unit 11 and the history element information correspondingly to each other, and accumulates the history information of the user.

The rule storage unit 15 stores a rule having the conditions under which an output of the history information of the user to the service server 3 is authorized, and, for example, stores a rule that specifies the condition in the case that the user is present in a certain predetermined range, the condition in the case that the user has visited a certain shop and the like. Additionally, the rule may be set for each service that the service server provides, and may be set for each attribute of the history information that the service server requests, for example, may be set for each piece of the position information, each piece of the visit information, and the like, and further may be set for each user identifier of the user that receives the service.

The authorization list storage unit 16 stores, for each rule, the authorization list having a list of the user identifiers listed therein that authorizes an output of the history information of the user to the service server 3.

The rule assessment unit 12 lists the user identifiers of which the assessment element information meets the rule in the authorization list corresponding to the rule, based on the rule stored in the rule storage unit 15 and the assessment element information, being an element for assessing the rule, out of the user information. Further, when the user identifier of which the assessment element information does not meet the rule is listed in the authorization list, the rule assessment unit 12 deletes the above user identifier. In such a manner, the rule assessment unit 12 updates the authorization list, being a list for authorizing an output of the history information of the user to the service server 3, whenever receiving the user information including the assessment element information.

The filtering unit 13, upon receipt of a request of the history information coming from the service server 3, for example, a request of the history information for designating the server name and the rule, extracts from the history information storage unit 14 the history information of the user corresponding to the user identifier listed in the authorization list of the authorization list storage unit 16 that corresponds to the server name and the rule, and provides the extracted history information of the user to the service server 3.

As mentioned above, this exemplary embodiment makes it possible to provide the history information when the service having a high effectiveness can be provided to the user because the user identifier of the user meeting the rule is listed in the authorization list, for example, based on the rule in the case that the service having a high effectiveness can be provided to the user, and the history information of the user corresponding to the user identifier listed in the above authorization list is transmitted to the service server at the moment of putting the history information of the user into practical use and providing the information.

Further, this exemplary embodiment makes it possible to drastically lessen a storage region for storing the history information because there is no necessity for accumulating the history information for each service, for each classification of the history, and for each user.

Hereinafter, specific exemplary embodiments are explained.

### First Exemplary Embodiment

Next, the first exemplary embodiment of the present invention will be explained in details by referencing the accompanied drawings.

In the first exemplary embodiment, an example in which the contents server provides the contents such as the area information to the user terminal existing in a predetermined area range (hereinafter, described as a service area) will be explained. Additionally, it is enough that the number of the service areas and the contents servers is at least one or more, respectively.

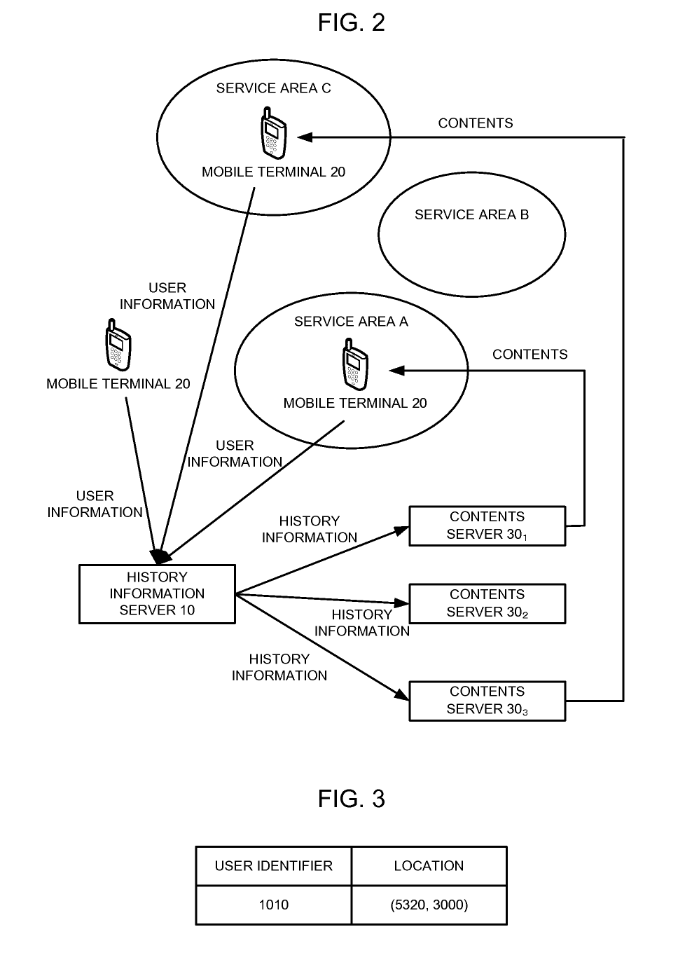

Upon referencing FIG. 2, the system in the first exemplary embodiment includes a history information server 10, a user terminal 20, contents servers 30₁ to 30₃.

The user terminal 20, which is an information processing device that includes an input device such as a button and a sensor, an output device such as a liquid crystal display, a processing device including CPU (central Processing Unit), and a storage device including a memory, generates the user information at an arbitrary time point, and transmits the user information to the history information server 10.

The user information of the first exemplary embodiment includes the user identifier for identifying the user or the user terminal, and the information, being the history element information that becomes an element of the history information of the user and the assessment element information, and the assessment element information that becomes an element for assessing whether to provide the history information of the user to the contents server 30. This information is information that includes at least one attribute or more. The attribute includes at least an attribute name and an attribute value. A specific example of the user information acquired at an arbitrary time point is shown in FIG. 3. The example shown in FIG. 3, which illustrates the user information of the user that is identified by a user identifier 1010, is an example of the case of including one attribute as the information. The attribute name in the attribute is LOCATION (position information of the user terminal), and the attribute value is a coordinate (5320, 3000). In the following, the case in which the user information includes the user identifier, the attribute name LOCATION (position information of the user terminal) and the attribute value will be explained. Additionally, each of the attribute name LOCATION (position information of the user terminal) and the attribute value become both of the history element information and the assessment element information in the first exemplary embodiment.

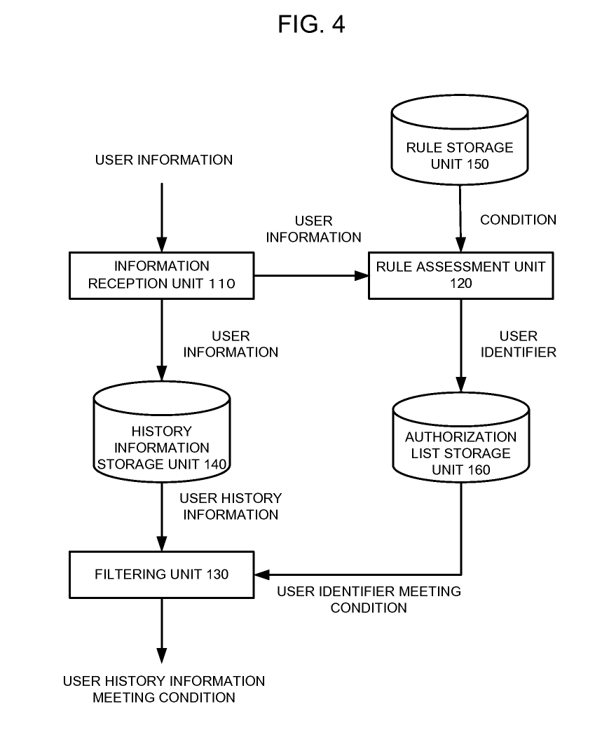

The history information server 10, as shown in FIG. 4, includes a user information reception unit 110, a rule assessment unit 120, a filtering unit 130, a history information storage unit 140, a rule storage unit 150, and an authorization list storage unit 160. Such a history information server 10 can be configured of the information processing device that includes the input device such as a mouse and a keyboard, the output device such as a liquid crystal display, the processing device including CPU, and the storage device including a memory. Additionally, each of the input device such as a mouse and a keyboard and the output device such as a liquid crystal display may be connected only at the time of inputting data and at the time of maintenance.

Next, each component to be included in the history information server 10 will be explained.

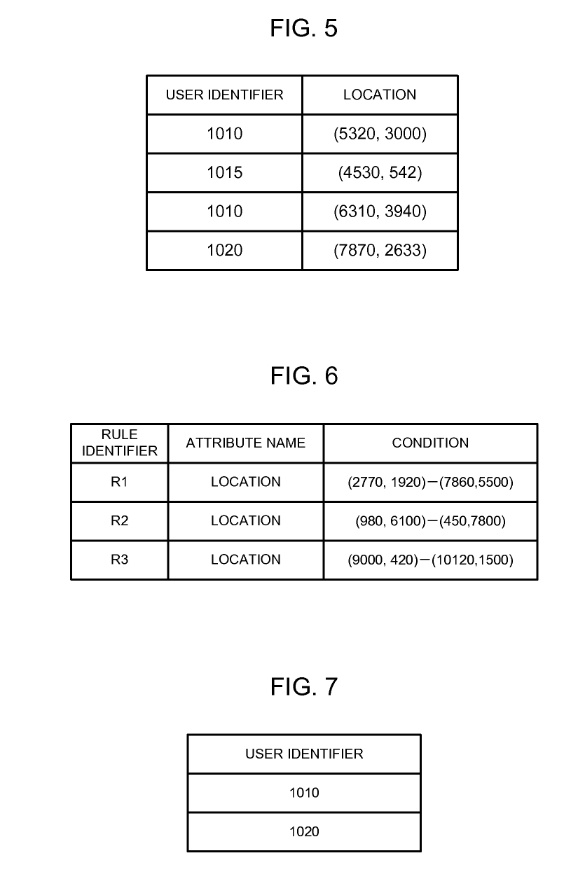

The user information reception unit 110, upon receipt of the user information from the user terminal 20, adds the above user information to the history information storage unit 140. The user information including the history element information and the user identifiers is sequentially accumulate into the history information storage unit 140, and the accumulated user information become the history information of the user. Further, the history information accumulated in the history information storage unit 140 is the history information of a plurality of the users. A specific example of the history information accumulated in the history information storage unit 140 is shown in FIG. 5. In an example of FIG. 5, the user history element information of three users to be identified by user identifiers 1010, 1015, and 1020, respectively, is accumulated in an order in which the user information has been received.

Further, the user information reception unit 110 delivers the acquired user information to the rule assessment unit 120.

The rule storage unit 150 stores the rule that lays down the conditions under which the provision of the history information of the user to the contents server 30 is authorized when a request of the history information of the user is received from the contents server 30. Herein, the so-called rule is the condition under which the user from whom a high effect, for example, an effect that the user auditions the provided contents and an effect that the user utilizes the goods and the services introduced within the contents can be expected is selected at the moment that the contents server 30 provides the contents to the user, and is the information including the attribute name, and the range and condition etc. of the attribute value of the above attribute name. The rule can be identified by the rule identifier. A specific example of the rule is shown in FIG. 6. In an example shown in FIG. 6, the rules corresponding to three contents servers, respectively, are shown, and for example, the rule corresponding to the contents server 30₁ of which the rule identifier is R1 is a rule of, when the condition that the attribute value of the attribute name “LOCATION” included in the user information is within a range of coordinate (2770, 1920)-(7860, 5500) is met, providing the history information relating to the user to be identified by the user identifier included in the above user information to the contents server, or a rule of authorizing an access to the above history information from contents server 30₁. Additionally, the above-described range of the attribute value could be a circle and a polygon in addition to a rectangle.

The authorization list storage unit 160 keeps the authorization list in which, for each rule, the user identifiers meeting the above rule are listed.

The rule assessment unit 120, upon receipt of the user information from the user information reception unit 110, assesses whether the attribute and attribute value of the above user information meet the rule stored in the rule storage unit 150. When they meet, the rule assessment unit 120 assesses whether the user identifier of the user information meeting the rule is listed in the authorization list corresponding to the above rule, and when it is not listed in the authorization list, the rule assessment unit 120 adds the above user identifier to the authorization list. For example, when the attribute value of the attribute name “LOCATION” of the received user information is within a range of coordinate (2770, 1920)-(7860, 5500), being the condition of the rule identifier R1, the rule is met, whereby when the user identifier of the received user information is not listed in the authorization list corresponding to the rule identifier R1, the rule assessment unit 120 adds the above user identifier.

On the other hand, when the attribute and attribute value of the user information do not meet the rule, the rule assessment unit 120 assesses whether the user identifier of the user information not meeting the rule is included in the authorization list corresponding to the above rule, and when it is included, the rule assessment unit 120 deletes the above user identifier from the authorization list. One example of the authorization list to or from which the user identifier is added or deleted by the rule assessment unit 120 is shown in FIG. 7. The user identifier 1010 and the user identifier 1020 are listed in this authorization list.

The filtering unit 130, upon receipt of a request of the history information coming from the contents server 30, clears a temporary storage region that keeps the history information subjected to the filtering. And, the filtering unit 130 reads out each piece of the user information included in the history information stored in the history information storage unit 140, and executes the following processes. At first, the filtering unit 130 assesses whether the user identifier included in the user information is included in the authorization list corresponding to the rule of the contents server 30 having requested a request of the history information. The filtering unit 130 adds the history information corresponding to the user identifier included in the authorization list to the temporary storage region for keeping the history information subjected to the filtering when the user identifier is included in the authorization list. And, the filtering unit 130 delivers the history information of the user identifier meeting the rule kept in the temporary storage region to the contents server 30.

The contents server 30 is an information processing device that includes the input device such as a mouse and a keyboard, the output device such as a liquid crystal display, the processing device including CPU, and the storage device including a memory. Additionally, each of the input device such as a mouse and a keyboard and the output device such as a liquid crystal display may be connected only at the time of inputting data and at the time of maintenance.

The contents server 30 requests the history information of the history information server 10, and receives the history information from the history information server 10. Next, the contents server 30 generates the contents including sales information of neighboring shops based on the user information included in the received history information. And, the contents server 30 deliverers the contents to the user terminal 20 that is identified by the user identifier included in the user information.

Next, an operation of the first exemplary embodiment configured as described above will be explained.

The history information server 10 in the first exemplary embodiment performs different operations at the time of having received the user information from the user terminal 20 and at the time of having received the history information from the contents server 30, respectively.

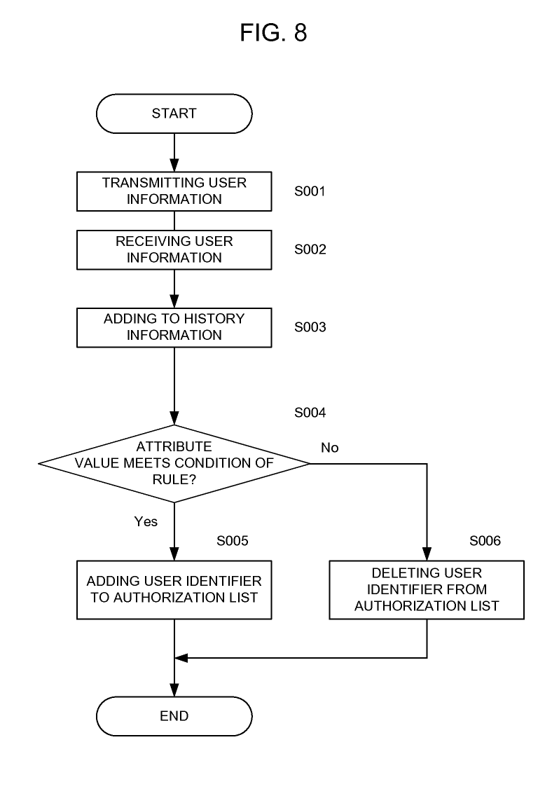

At first, the details of an operation at the time when the history information server 10 has received the user information from the user terminal 20 will be explained by employing a flowchart of FIG. 8.

(S001) The user terminal 20 transmits the user information to the history information server 10.

(S002) The user information reception unit 110 of the history information server 10 receives the user information (the user identifier, the attribute name “LOCATION”, and the attribute value) from the user terminal 20.

(S003) The user information reception unit 110 adds the acquired user information to the history information kept in the history information storage unit 140. And, the user information reception unit 110 delivers the acquired user information to the rule assessment unit 120.

(S004) The rule assessment unit 120, upon receipt of the user information from the user information reception unit 110, assesses whether the attribute value of the attribute in the user information meets the condition of the rule stored in the rule storage unit 150. The rule assessment unit 120 executes S005 when it meets. The rule assessment unit 120 executes S006 when it does not meet.

(S005) The rule assessment unit 120 assesses whether the user identifier meeting the rule is included in the authorization list of the rule that is met in authorization lists storage unit 160 when it meets the rule, and adds the user identifier of the user information meeting the rule to the above authorization list when it is not included. Herein, a flow of this operation is finished.

(S006) When it does not meet the rule, the rule assessment unit 120 assesses whether the user identifier of the user information not meeting the above rule is included in the authorization list of the rule that is not met in the authorization list storage unit 160, and when the above user identifier is included, the rule assessment unit 120 deletes the user identifier of the user information not meeting the rule from the above authorization list. Herein, a flow of this operation is finished.

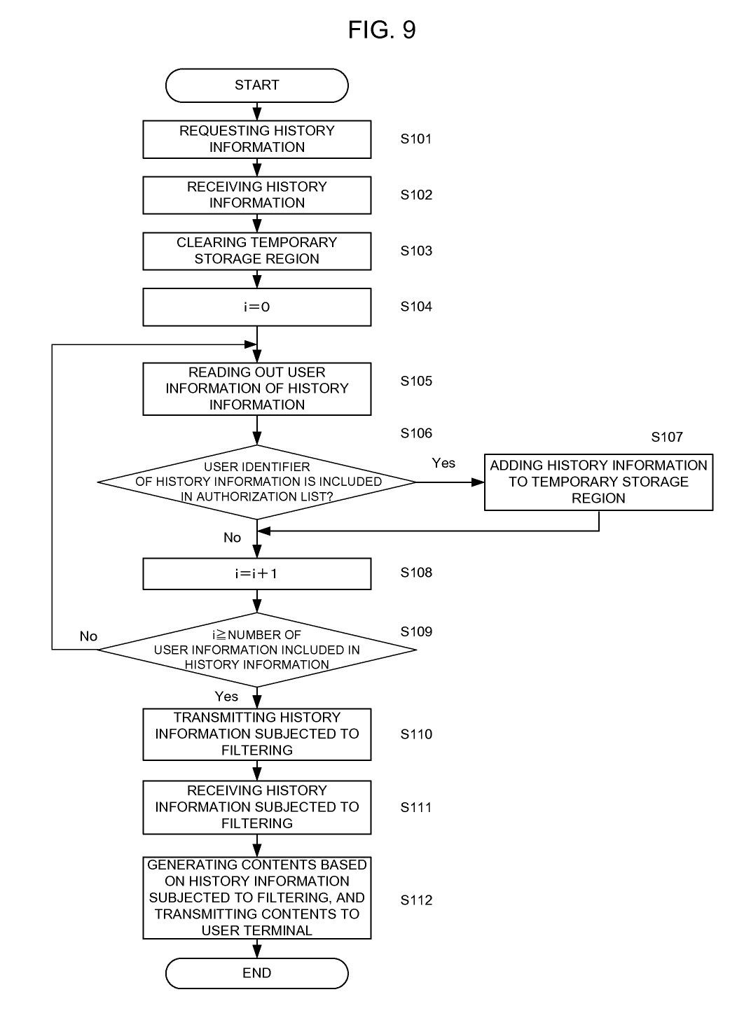

Next, the details of an operation at the time when the history information server 10 has received the history information from the contents server 30 will be explained by employing a flowchart of FIG. 9.

(S101) The contents server 30 delivers a request of the history information to the history information server 10.

(S102) The filtering unit 130 of the history information server 10 receives a request of the history information from the contents server 30.

(S103) The filtering unit 130 clears the temporary storage region that keeps the history information subjected to the filtering.

(S104) The filtering unit 130 initializes variable i to 0 (zero).

(S105) The filtering unit 130 reads out user information i included in the history information that the history information storage unit 140 keeps.

(S106) The filtering unit 130 assesses whether the user identifier included in the user information i is included in the authorization list corresponding to the rule of the contents server 30 having requested the history information kept in the authorization list storage unit 160. The filtering unit 130 executes S107 when the above user identifier is included in the authorization list. The filtering unit 130 executes S108 when it is not included.

(S107) The filtering unit 130 adds the user information i stored in the history information storage unit 140 to the temporary storage region that keeps the history information subjected to the filtering.

(S108) The filtering unit 130 increases the value of the variable i by 1.

(S109) The filtering unit 130 assesses whether the value of the variable i is equal to more than the number of the user information included in the history information that the history information storage unit 140 keeps. The filtering unit 130 executes S110 when it is true. The filtering unit 130 executes S105 when it is false.

(S110) The filtering unit 130 delivers the history information subjected to the filtering kept in the temporary storage region to the contents server 30.

(S111) The contents server 30 receives the history information subjected to the filtering from the history information server 10.

(S112) The contents server 30 generates the contents including the sales information of neighboring shops based on the user information included in the received history information. And, the contents server 30 delivers the generated contents to the user terminal that is identified by the user identifier included in the user information. Herein a flow of this operation is finished.

The first exemplary embodiment makes it possible to provide to the contents server the history information of the terminal from which a high effect, for example, an effect that the user auditions the provided contents for the delivery of the contents and an effect that the user utilizes the goods and the services introduced within the contents for the delivery of the contents can be acquired.

The reason is that the rule assessment unit 120 assesses the assessment element information of the user information whenever receiving the user information, based on the rule including the condition relating to the user information at the time when a high effect can be expected for the delivery of the contents, keeps the above user identifier in the authorization list when the assessment element information satisfies the rule, and deletes the user identifier not satisfying the rule from the authorization list. This allows only the history information corresponding to the user identifier meeting the rule to be provided to the contents server.

Further, the first exemplary embodiment makes it possible to effectively accumulate the history information in the restricted storage resource because there is no necessity for separately including, for each of the rules that respective contents servers request, the history information meeting the above rule.

In addition, a configuration may be made so that in order to prevent the wasteful history information, from which a high effect cannot be expected so much with regard to the delivery of the contents, from being kept, when the rule assessment unit 120 has assessed that the attribute of the user information does not meet to the rule, the rule assessment unit 120 delivers the user identifier included in the above user information to the user information reception unit 110, and the user information reception unit 110 deletes the history information corresponding to the delivered user identifier from the history information storage unit 140.

Making a configuration in such a manner makes it possible to realize the system for effectively accumulating the history information in the limited storage region all the more.

### Second Exemplary Embodiment

A system configuration of the second exemplary embodiment is similar to that of the first exemplary embodiment; however, the former differs from the latter in the details of the user information that the user terminal 20 transmits to the history information server 10, and in the history information to be provided to the contents server 30.

In the second exemplary embodiment, the user terminal 20 generates the position information or the visit information at respective arbitrary time points, and transmits it as the user information to the history information server 10. The position information is the user information including the attribute of which the attribute name is LOCATION, and becomes the assessment element information. Further, the visit information is the user information including the attribute of which the attribute name is SHOP_VISIT, and becomes the history element information and the assessment element information. Additionally, the position information and the visit information may be transmitted to the history information server 10 as one piece of the user information. Further, in the second exemplary embodiment, it is assumed that the history information to be provided to the contents server 30 is the visit information, being the information such as the shops that the user has visited.

Next, the part in which the second exemplary embodiment differs from the first exemplary embodiment, out of respective component elements to be included in the history information server 10, will be explained.

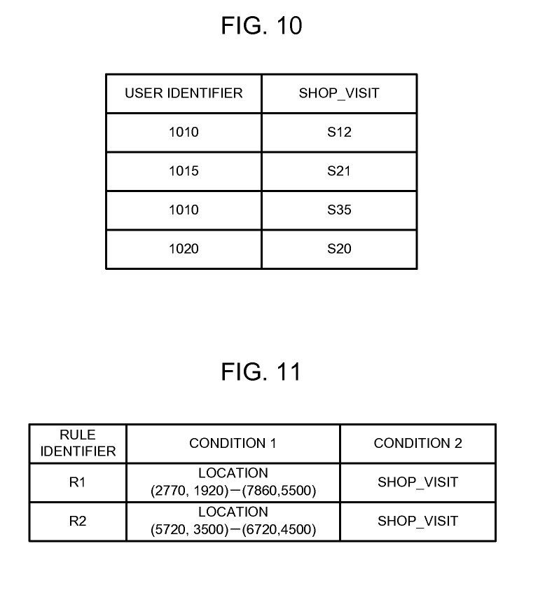

If, when the user information reception unit 110 receives the user information from the user terminal 20, the visit information is included in the above user information, the user information reception unit 110 adds the above visit information to the history information storage unit 140 together with the user identifier. A specific example of the history information is shown in FIG. 10. In an example of FIG. 10, the visit information (attribute name SHOP_VISIT) of three users to be identified by user identifiers 1010, 1015, and 1020, respectively, is accumulated in an order, and the information saying that the user with the user identifier 1010 has visited a shop S12 is recorded.

Further, if, when the user information reception unit 110 receives the user information from the user terminal 20, the position information is included in the above user information, the user information reception unit 110 delivers the above position information to the rule assessment unit 120 together with the user identifier.

The rule storage unit 150, similarly to the first exemplary embodiment, stores the rule for each contents server, namely, the information including the attribute name in the user information, the condition of a range of the attribute value of the above attribute name, and the like. In the second exemplary embodiment, the rule storage unit 150 stores the information including the condition under which the history is provided to the contents server, and the target of the history that is provided at the time when the above condition is met. For the target, a classification of the history information of which the provision is authorized at the time when the condition is met is described with the attribute name. That is, differently from the first exemplary embodiment, the visit information (attribute name SHOP_VISIT) is the target of the history that is provided to the contents server. One example of the rule of the second exemplary embodiment is shown in FIG. 11. The rule R1 of FIG. 11 is a rule of deleting the user identifier from the authorization list when the value of the LOCATION attribute is not within a range of (2770, 1920)-(7860, 5500), and of adding the user identifier to the authorization list when the visit information (attribute name SHOP_VISIT) is included in the user information.

The rule assessment unit 120, upon receipt of the user information from the user information reception unit 110, assesses whether the visit information is included in the above user information based on the rule, assesses whether the user identifier of the above user information is included in the authorization list corresponding to the rule when it is included, and adds the above user identifier to the authorization list when it is not included.

Further, the rule assessment unit 120, upon receipt of the user information including the position information from the user information reception unit 110, assesses whether the attribute value of the position information of the received user information meets the condition of the rule of the rule storage unit 150. Further, the rule assessment unit 120 assesses whether the user identifier of the above user information is included in the authorization list when it does not meet, and deletes the user identifier from the authorization list when it is included.

The filtering unit 130, upon receipt of a request of the history information from the contents server 30, firstly clears the temporary storage region that keeps the history information subjected to the filtering. Next, the filtering unit 130 reads out each piece of the visit information included in the history information that the history information storage unit 140 keeps, and executes the following processes.

The filtering unit 130 assesses whether the user identifier included in the visit information is included in the authorization list that the authorization list storage unit 160 keeps. The filtering unit 130 adds the visit information to the temporary storage region that keeps the history information subjected to the filtering when it is included. And, the filtering unit 130 delivers the filtered history information to the contents server 30.

The contents server 30 delivers a request of the history information to the history information serve 10, and receives the history information from the history information server 10. Next, the contents server 30 generates the contents including the sales information of the neighboring shops based on the visit information included in the received history information. And, the contents server 30 deliverers the generated contents to the user terminal 20 that is identified by the user identifier included in the visit information.

The history information server 10 in the second exemplary embodiment performs different operation at the time of having received the visit information from the user terminal 20, at the time of having received the position information from the user terminal 20, and at the time of having received the history information from the contents server 30, respectively.

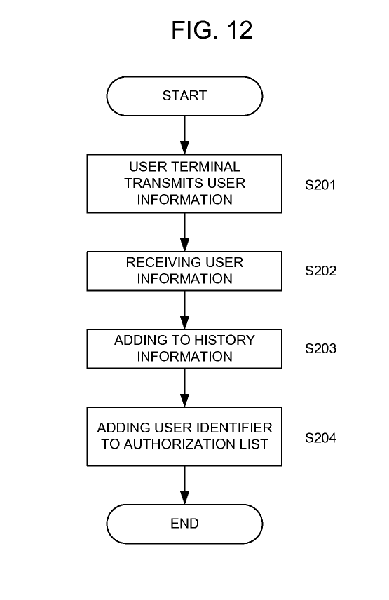

At first, the details of an operation at the time when the history information server 10 has received the visit information from the user terminal 20 will be explained by employing a flowchart of FIG. 12.

(S201) The user terminal 20 delivers the user information including the visit information to the history information server 10.

(S202) The user information reception unit 110 of the history information server 10 receives the user information including the visit information from the user terminal 20.

(S203) The user information reception unit 110 adds the user information including the visit information to the history information kept in the history information storage unit 140. And, the user information reception unit 110 delivers the user information including the visit information to the rule assessment unit 120.

(S204) The rule assessment unit 120, upon receipt of the user information including the visit information from the user information reception unit 110, assesses whether the user identifier of the user information is included in the authorization list, and adds the user identifier to the aforementioned authorization list when it is not included. Herein, a flow of this operation is finished.

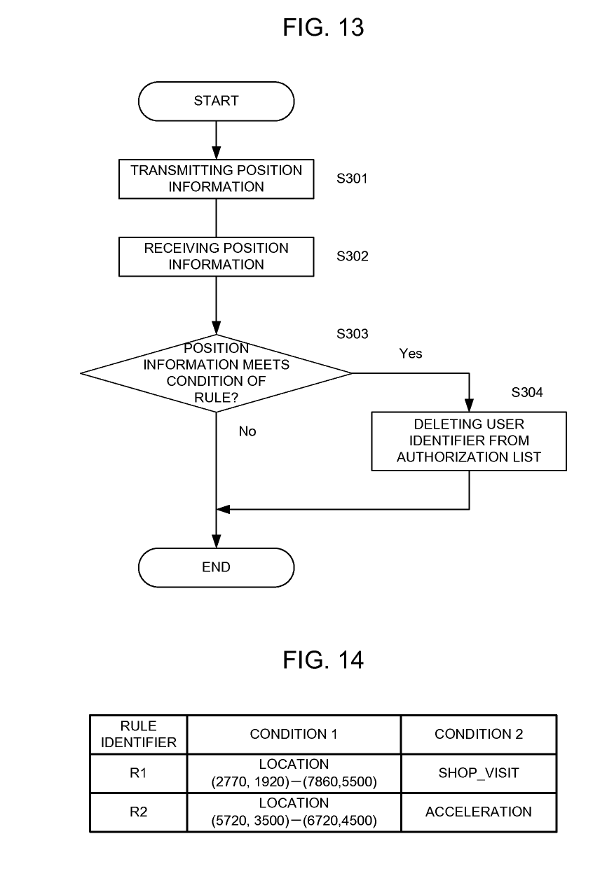

Next, the details of an operation at the time when the history information server 10 has received the position information from the user terminal 20 will be explained by employing a flowchart of FIG. 13.

(S301) The user terminal 20 delivers the user information including the position information to the history information server 10.

(S302) The rule assessment unit 120 of the history information server 10 receives the user information including the position information from the user terminal.

(S303) The rule assessment unit 120 assesses whether the attribute value of the position information meets the condition of the rule of the rule storage unit 150. When it meets, a flow of this operation is finished herein. When it does not meet, the rule assessment unit 120 executes S304.

(S304) The rule assessment unit 120 assesses whether the user identifier not meeting the rule is included in the authorization list, and deletes the above user identifier from the authorization list when it is included. Herein, a flow of this operation is finished.

An operation at the time when the history information server 10 has received a request of the history information from the contents server 30 is similar to that of the first exemplary embodiment, so explanation is omitted.

An effect in the second exemplary embodiment lies in a point that the second exemplary embodiment can cope with the case in which the history information (for example, the visit history information) and the current attribute (for example, the current position information of the user), being a reference for assessing whether to provide the history information, differ from each other in a kind.

### Third Exemplary Embodiment

The third exemplary embodiment will be explained.

The rule to be stored in the rule storage unit 150 can be kept user by user. In that case, the rule assessment unit 120, upon receipt of the user information, firstly retrieves, from the rule storage unit 150, the rule registered correspondingly to the user identifier included in the received user information. Next, the rule assessment unit 120 assesses whether the attribute in the above user information meets the rule founded as a result of the retrieval.

There is a case in which while a certain user is annoyed at the provision of the information of the neighboring bock in which he/her walked a little ago, another user is happy about the provision of the town information during his/her stay in the same municipality.

An effect in the third exemplary embodiment of the present invention lies in a point that the third exemplary embodiment can put the history information into practical use to such individual users.

### Fourth Exemplary Embodiment

The fourth exemplary embodiment will be explained.

The fourth exemplary embodiment is also similar to the second exemplary embodiment in terms of the basic configuration; however, the details of the user information that the user terminal 20 transmits to the history information server 10 differ. In the fourth exemplary embodiment, the user terminal 20 generates the position information, the visit information, and the acceleration information at respective arbitrary time points in addition to the user identifier, and transmits them to the history information server 10. Additionally, the acceleration information is the user information including the attribute of which the attribute name is ACCELERATION. Out of these position information, visit information, and acceleration information, the visit information and the acceleration information are accumulated as the history element information in the history information storage unit 140. Further, the position information, the visit information, and the acceleration information become the assessment element information that is applied for assessing the rule as to whether to provide the history to the contents server.

Next, the part in which the fourth exemplary embodiment of the present invention differs from the second exemplary embodiment, out of respective component elements to be included in the history information server 10, will be explained.

The rule storage unit 150 stores a plurality of the rules. The rule includes the condition under which the history is provided to the contents server, and the target of the history that is provided at the time when the above condition is met. For the target, a classification of the history information of which the provision is authorized at the time when the condition is met is described with the attribute name. Additionally, a range of the attribute value within which the provision is authorized can be also described for the target.

A specific example of the rule is shown in FIG. 14. A rule R1 is a rule of authorizing a request by the contents server 30 for the history information relating to the attribute SHOP_VISIT of a user of which the value of the LOCATION attribute is within a range of coordinate (2770, 1920)-(7860, 5500). That is, when the information of the user information is the attribute SHOP_VISIT, it is assessed whether the user identifier included in the received user information is listed in the authorization list corresponding to the above attribute. And, when the above user identifier is not listed in the authorization list, the user identifier is added to the authorization list. Further, if, when the information of the received user information is the attribute LOCATION of the received user information, the above attribute value is not within a range of the coordinate (2770, 1920)-(7860, 5500) and the user identifier is listed in the authorization list, the above user identifier is deleted.

Further, A rule R2 is a rule of authorizing an access to the history information relating to the attribute ACCELERATION of the user of which the value of the attribute is within a range of coordinate (5720, 3500)-(6720, 4500). That is, when the information of the user information is the attribute ACCELERATION, it is assessed whether the user identifier included in the received user information is listed in the authorization list corresponding to the above attribute. And, when the above user identifier is not listed in the authorization list, the user identifier is added to the authorization list. Further, if, when the information of the received user information is the attribute LOCATION of the received user information, the above attribute value is not within a range of coordinate (5720, 3500)-(6720, 4500) and the user identifier is listed in the authorization list, the above user identifier is deleted from the authorization list.

The user information reception unit 110, upon receipt of the user information including the visit information (the user information including the attribute of which the attribute name is SHOP_VISIT) or the acceleration information (the user information including the attribute of which the attribute name is ACCELERATION) from the user terminal 20, records the above user information into the history information storage unit 140. Further, the user information reception unit 110 outputs the received user information to the rule assessment unit 120.

The authorization list storage unit 160 keeps the authorization lists corresponding to the rule, namely the authorization lists corresponding to the attribute name of the history information to be provided to the contents server 30 in a plural number.

The rule assessment unit 120, upon receipt of the user information from the user information reception unit 110, assesses the information included in the user information, and assesses whether, when the above information is the attribute SHOP_VISIT or the attribute ACCELERATION, the user identifier included in the received user information is listed in the authorization list corresponding to the above attribute. And, when the above user identifier is not listed in the authorization list, the rule assessment unit 120 adds the user identifier to the authorization list. Further, when the information of the received user information is the attribute LOCATION, the rule assessment unit 120 assesses whether the condition of each rule is met. When it is not met, the rule assessment unit 120 assesses whether the user identifier of the received user information is listed in the authorization list corresponding to the attribute of the target that is conditioned on the attribute LOCATION, and when the user identifier is listed in the above authorization list, the rule assessment unit 120 deletes the above user identifier.

The contents server 30 delivers to the history information server 10 the attribute name representing a classification of the history information that it requests, and receives the history information corresponding to the aforementioned attribute name from the aforementioned history information server. Additionally, the contents server 30 provides the service by using the acceleration information as well in some cases. Next, the contents server 30 generates the contents including the sales information of the neighboring shops and the like based on the visit information included in the aforementioned received history information. Next, the contents server 30 delivers the aforementioned contents to the user terminal 20 that is identified by the user identifier included in the aforementioned visit information.

An operation of the fourth exemplar embodiment will be explained.

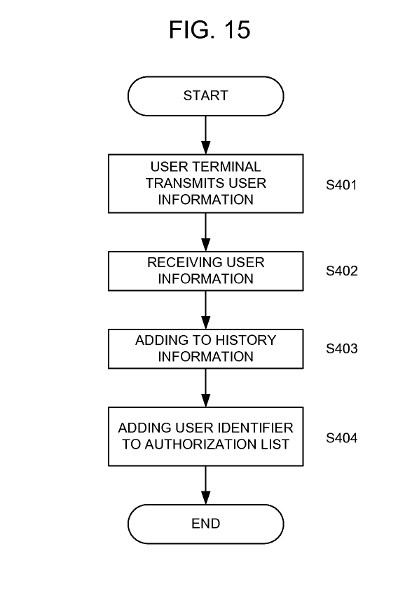

At first, the details of an operation at the time when the history information server 10 has received the user information including the visit information or the acceleration information from the user terminal 20 will be explained by employing a flowchart of FIG. 15.

(S401) The user terminal 20 delivers the user information to the history information server 10.

(S402) The user information reception unit 110 in the history information server 10 receives the user information from the user terminal.

(S403) The user information reception unit 110 adds the user information to the history information corresponding to the attribute name included in the received user information. Next, the user information reception unit 110 delivers the user information to the rule assessment unit 120.

(S404) The rule assessment unit 120, upon receipt of the user information, assesses whether the user identifier of the received user information is included in the authorization list corresponding to the attribute name of the information included in the user information. And, when the user identifier is not included, the rule assessment unit 120 adds the user identifier to the above authorization list. Herein, a flow of this operation is finished.

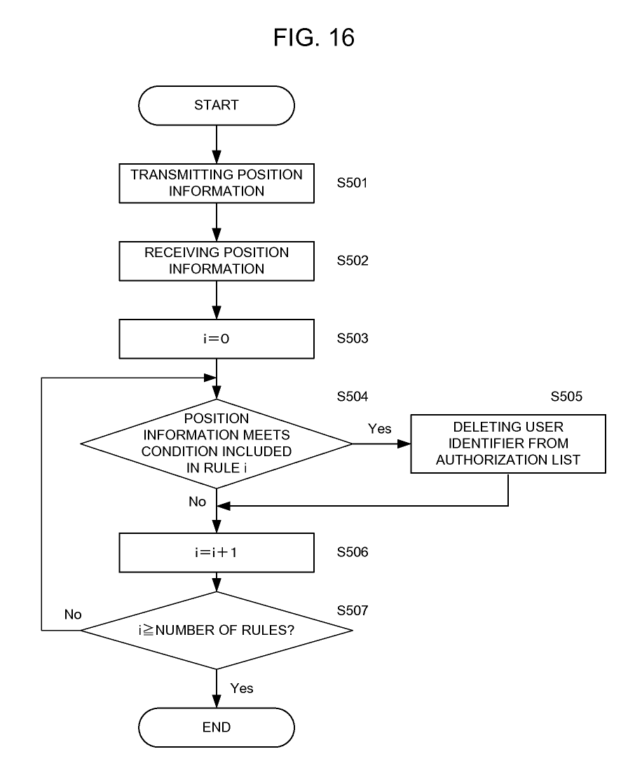

Next, the details of an operation at the time when the history information server 10 has received the position information from the user terminal 20 will be explained by employing a flowchart of FIG. 16.

(S501) The user terminal 20 delivers the position information to the history information server 10.

(S502) The rule assessment unit 120 in the history information server 10 receives the position information from the user terminal 20.

(S503) The rule assessment unit 120 initializes variable i to 0 (zero).

(S504) The rule assessment unit 120 assesses whether the attribute in the position information meets the condition of the rule i in the rule storage unit 150. When it meets, the rule assessment unit 120 executes S506. When it does not meet, the rule assessment unit 120 executes S505.

(S505) The rule assessment unit 120 assesses whether the user identifier in the aforementioned position information is included in the authorization list, and deletes the aforementioned user identifier from the aforementioned authorization list when it is included.

(S506) The rule assessment unit 120 increases the value of the variable i by 1.

(S507) The rule assessment unit 120 assesses whether the value of the variable i is equal to more than the total number of the rules that the rule storage unit 150 keeps. Herein, a flow of this action is finished when it is true. The rule assessment unit 120 executes S504 when it is false.

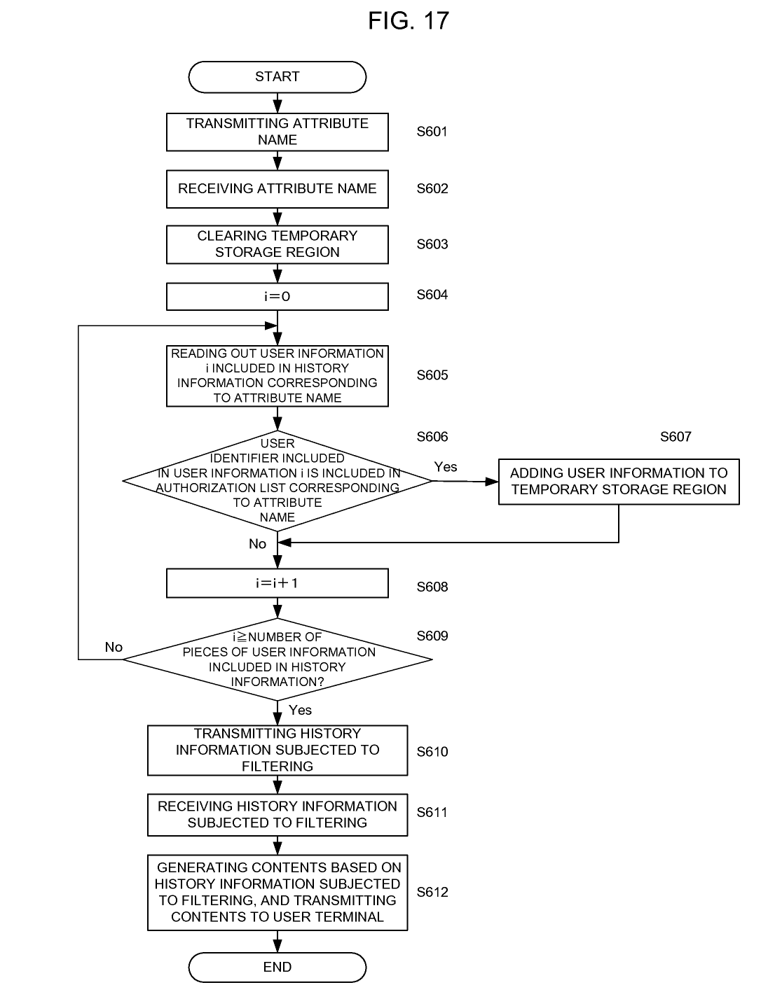

Next, the details of an operation at the time when the history information server 10 has received a request of the history information from the contents server 30 will be explained by employing a flowchart of FIG. 17.

(S601) The contents server 30 delivers the attribute name to the history information server 10.

(S602) The filtering unit 130 in the history information server 10 receives the attribute name from the contents server 30.

(S603) The filtering unit 130 clears the temporary storage region that keeps the history information subjected to the filtering.

(S604) The filtering unit 130 initializes variable i to 0 (zero).

(S605) The filtering unit 130 reads out user information i included in the history information corresponding to the aforementioned attribute name, out of a plurality of pieces of the history information that the history information storage unit 140 keeps.

(S606) The filtering unit 130 assesses whether the user identifier included in the aforementioned user information i is included in the authorization list corresponding to the aforementioned attribute name that the authorization list storage unit 160 keeps. The filtering unit 130 executes 5607 when it is included. The filtering unit 130 executes 5608 when it is not included.

(S607) The filtering unit 130 adds the user information i to the temporary storage region that keeps the history information subjected to the filtering.

(S608) The filtering unit 130 increases the value of the variable i by 1.

(S609) The filtering unit 130 assesses whether the value of the variable i is equal to more than the number of the user information included in the history information that the history information storage unit 140 keeps. The filtering unit 130 executes 5610 when it is true. The filtering unit 130 executes 5605 when it is false.

(S610) The filtering unit 130 delivers the history information subjected to the filtering to the contents server 30.

(S611) The contents server 30 receives the history information subjected to the filtering from the history information server 10.

(S612) The contents server 30 generates the contents including the sales information of the neighboring shops and the like based on the user information included in the received history information. Next, the contents server 30 delivers the generated contents to the user terminal that is identified by the user identifier included in the user information. Herein, a flow of this operation is finished.

Continuously, the above-described operation will be explained by employing a specific example.

At first, it is assumed that the history information corresponding to the attribute names ACCELERATION and SHOP_VISIT in the history information storage unit 140 is [ ] (it indicates that nothing is stored). Further, it is assumed that the attribution list corresponding to each attribute name in the authorization list storage unit 160 is also [ ] (it indicates that nothing is stored). Further, it is assumed that the rule kept in the rule storage unit 150 is shown in FIG. 14.

At first, it is assumed that the acceleration information of the user identifier 1010 has been acquired.

In the S402, the user information reception unit 110, upon receipt of user information {1010, ACCELERATION: 10}, adds the user information to the history information [ ] corresponding to the attribute name ACCELERATION included in the received user information in the S403. At this time, the history information corresponding to the attribute name ACCELERATION becomes [{1010, ACCELERATION: 10}].

Next, the user information reception unit 110 delivers the user identifier 1010 and the attribute name ACCELERATION included in the received user information to the rule assessment unit 120. And, in the S404, the rule assessment unit 120, upon receipt of the user identifier 1010 and the attribute name ACCELERATION from the user information reception unit 110, adds the received user identifier 1010 to the authorization list [ ] corresponding to the attribute name ACCELERATION. At this time, the authorization list corresponding to the attribute name ACCELERATION becomes [1010].

Next, it is assumed that the visit information of the user identifier 1010 has been acquired.

In the S402, the user information reception unit 110, upon receipt of user information {1010, SHOP_VISIT: S42}, adds the user information to the history information [ ] of the history information storage unit 140 corresponding to the attribute name SHOP_VISIT included in the received user information in the S403. At this time, the history information corresponding to the attribute name SHOP_VISIT becomes [{1010, SHOP_VISIT: S42}].

Next, the user information reception unit 110 delivers the user identifier 1010 and the attribute name SHOP_VISIT included in the user information to the rule assessment unit 120. And, in the S404, the rule assessment unit 120, upon receipt of the user identifier 1010 and the attribute name SHOP_VISIT from the user information reception unit 110, adds the user identifier 1010 to the authorization list [ ] corresponding to the attribute name SHOP_VISIT. At this time, the authorization list corresponding to the attribute name SHOP_VISIT becomes [1010].

From a result of the operation as mentioned above, the history information corresponding to the attribute name ACCELERATION in the history information storage unit 140 is [{1010, ACCELERATION: 10}], and the history information corresponding to the attribute name SHOP_VISIT is [{1010, SHOP_VISIT: S42}]. Further, the authorization list corresponding to the attribute name ACCELERATION in the authorization list storage unit 160 is [1010], and the authorization list corresponding to the attribute name SHOP_VISIT is [1010].

The filtering unit 130, upon receipt of the attribute name ACCELERATION from the contents server 30, executes the steps S603 to S609, and delivers the history information subjected to the filtering [{1010, ACCELERATION: 10} to the contents server 30.

The filtering unit 130, upon receipt of the attribute name SHOP_VISIT from the contents server 30, executes the steps S603 to S609, and delivers the history information subjected to filtering [{1010, SHOP_VISIT: S42}] to the contents server 30.

Next, it is assumed that the user 1010 has moved within a site of park in a certain town.

In the S502, the rule assessment unit 120, upon receipt of the position information {1010, LOCATION: (6310, 3940)} from the user terminal 20, initializes variable i to 0 (zero) in the S503. It is assumed that rule i at this time is the rule R1 stored in the rule storage unit 150.

In the S504, the rule assessment unit 120 assesses that point coordinate to be designated by the attribute value (6310, 3940) of the attribute LOCATION in the position information is within a range to be designated by the condition (2770, 1920)-(7860, 5500) of the rule R1 in the rule storage unit 150, and executes S506. In the S506, a list management unit increases the value of variable i by 1. It is assumed that rule i at this time is the rule R2 in a rule management unit. In the S507, the list management unit assesses that the value 1 of the variable i is less than a total number 2 of the rules that the rule storage unit 150 keeps, and executes the S504.

In the S504, the rule assessment unit 120 assesses that point coordinate to be designated by the attribute value (6310, 3940) of the attribute LOCATION in the position information is within a range to be designated by the condition (5720, 3500)-(6720, 4500) of the rule R2 in the rule storage unit 150, and executes S506. In the S506, the rule assessment unit 120 increases the value of the variable i by 1. In the S507, the rule assessment unit 120 assesses that the value 2 of the variable i is equal to or more than a total number 2 of the rules that the rule storage unit 150 keeps, and finishes the operation.

At this time, the authorization list corresponding to the attribute name ACCELERATION in the authorization list storage unit 160 is [1010], and the authorization list corresponding to the attribute name SHOP_VISIT is [1010].

The filtering unit 130, upon receipt of the attribute name ACCELERATION from the contents server 30, executes the steps S603 to S609, and delivers the history information subjected to the filtering [{1010, ACCELERATION: 10}] to the contents server 30. The filtering unit 130, upon receipt of the attribute name SHOP_VISIT from the contents server 30, executes the steps S603 to S609, and delivers the history information subjected to the filtering [{1010, SHOP_VISIT: S42} to the contents server 30.

Next, it is assumed that the user 1010 has moved outsides the site of the park. However, it is assumed that the user 1010 stays within the town.

In the S502, the rule assessment unit 120, upon receipt of the position information {1010, LOCATION: (7470, 4520)} via the user information reception unit 110 from the user terminal 20, initializes the variable i to 0 (zero) in the S503. It is assumed that rule i at this time is the rule R1 in the rule storage unit 150. In the S504, the rule assessment unit 120 assesses that point coordinate to be designated by the attribute value (7470, 4520) of the attribute LOCATION in the position information is within a range to be designated by the condition (2770, 1920)-(7860, 5500) of the rule R1 in the rule storage unit 150, and executes S506. In the S506, the rule assessment unit 120 increases the value of the variable i by 1.

It is assumed that the rule i at this time is the rule R2 in a rule storage unit 150. In the S507, the rule assessment unit 120 assesses that the value 1 of the variable i is less than a total number 2 of the rules that the rule storage unit 150 keeps, and executes the S504. In the S504, the rule assessment unit 120 assesses that point coordinate to be designated by the attribute value (7470, 4520) of the attribute LOCATION in the position information is not within a range to be designated by the condition (5720, 3500)-(6720, 4500) of the rule R2 in the rule storage unit 150, and executes S505. In the S505, the rule assessment unit 120 assesses that the user identifier 1010 in the position information is included in the authorization list [1010] corresponding to the attribute name ACCELERATION to be designated by the target of the rule R2, and deletes the user identifier 1010 from the above authorization list [1010].

In the S506, the rule assessment unit 120 increases the value of the variable i by 1. In the S507, the rule assessment unit 120 assesses that the value 2 of the variable i is equal to or more than a total number 2 of the rules that the rule storage unit 150 keeps, and finishes the operation.

At this time, the authorization list corresponding to the attribute name ACCELERATION is [ ], and the authorization list corresponding to the attribute name SHOP_VISIT is [1010]. An output of the acceleration information has been prohibited because the user 1010 has gone out from the site of the park; however, an output of the visit information has been authorized.

The filtering unit 130, upon receipt of the attribute name ACCELERATION from the contents server 30, executes the steps S603 to S609, and delivers the history information subjected to the filtering to the contents server 30. Additionally, in this case, there is no corresponding history information because the authorization list is [ ]. Further, the filtering unit 130, upon receipt of the attribute name SHOP_VISIT from the contents server 30, executes the steps S703 to S709, and delivers the history information subjected to the filtering [{1010, SHOP_VISIT: S42} to the contents server 30.

Next, it is assumed that the user 1010 has moved outsides the town.

The rule assessment unit 120, upon receipt of the position information {1010, LOCATION: (9170, 4850)} from the user terminal 20 in the S502, initializes the variable i to 0 (zero) in the S503. It is assumed that rule i at this time is the rule R1 in the rule storage unit 150. In the S504, the rule assessment unit 120 assesses that point coordinate to be designated by the attribute value (9170, 4850) of the attribute LOCATION in the position information is not within a range to be designated by the condition (2770, 1920)-(7860, 5500) of the rule R1 in the rule storage unit 150, and executes S505.

In the S505, the rule assessment unit 120 assesses that the user identifier 1010 in the position information is included in the authorization list [1010] corresponding to the attribute name SHOP_VISIT to be designated by the target of the rule R1, and deletes the aforementioned user identifier 1010 from the authorization list [1010].

In the S506, the rule assessment unit 120 increases the value of the variable i by 1. It is assumed that the rule i at this time is the rule R2 in the rule storage unit 150.

In the S507, the rule assessment unit 120 assesses that the value 1 of the variable i is less than a total number 2 of the rules that the rule storage unit 150 keeps, and executes the S504. In the S504, the rule assessment unit 120 assesses that point coordinate to be designated by the attribute value (9170, 4850) of the attribute LOCATION in the position information is not within a range to be designated by the condition (5720, 3500)-(6720, 4500) of the rule R2 in the rule storage unit 150, and executes S505. In the S505, the rule assessment unit 120 assesses that the user identifier 1010 in the position information is not included in the authorization list [ ] corresponding to the attribute name ACCELERATION to be designated by the target of the rule R2, and executes the S506. In the S506, the rule assessment unit 120 increases the value of the variable i by 1. In the S507, the rule assessment unit 120 assesses that the value 2 of the variable is equal to or more than a total number 2 of the rules that the rule storage unit 150 keeps, and finishes the operation.

At this time, the authorization list corresponding to the attribute name ACCELERATION in the authorization list storage unit 160 is [ ] (it indicates that nothing is stored), and the authorization list corresponding to the attribute name SHOP_VISIT is also [ ] (it indicates that nothing is stored). That is, an output of the visit information has been also prohibited because the user 1010 has gone out from the town.

The filtering unit 130, upon receipt of the attribute name ACCELERATION from the contents server 30, executes the steps S603 to S609, and delivers the history information subjected to the filtering [ ] to the contents server 30; however, no history information is outputted at all. Likewise, the filtering unit 130, upon receipt of the attribute name SHOP_VISIT from the contents server 30, executes the steps S603 to S609, and delivers the history information subjected to the filtering [ ] to the contents server 30; however, no history information is outputted at all.

While some pieces of the history information can be effectively put to practical use only in a narrow range such as a block unit of the town, some pieces of the history information can be effectively put to practical use in a wide range such as the municipality, dependent upon a classification of the history information.

An effect of the fourth exemplary embodiment of the present invention lies in a point that it also can cope with the case as well in which the effective utilization range differs in terms of a classification of the history information.

### Example 1

The example 1 of the present invention will be explained.

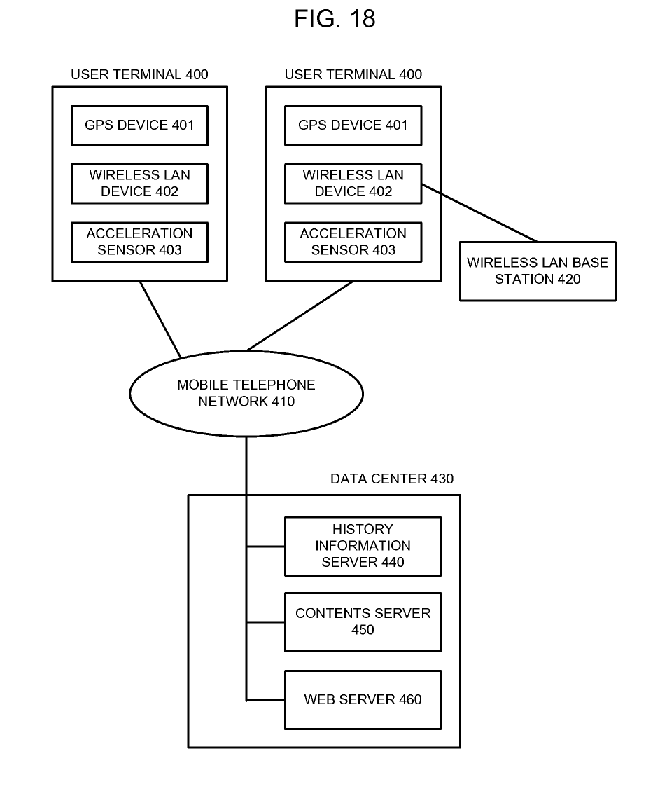

The example 1 is one obtained by furthermore materializing the fourth exemplary embodiment. Upon referencing FIG. 18, the example 1 includes a user terminal 400, a mobile telephone network 410, a wireless LAN base station 420, a data center 430, a history information server 440, a contents server 450, and a WEB server 460.

The user terminal 400, which is a mobile telephone machine, includes a GPS device 401, a wireless LAN device 402, and an acceleration sensor 403. Further, the GPS device 401 makes it possible to periodically measure longitude/attitude, and transmit the position information including the measured longitude/attitude to the history information server 440.

Further, the wireless LAN device 402 makes it possible to receive the identifier of the wireless LAN base station 420 existing in the vicinity, and transmit the visit information including the identifier to the history information server 440. Further, the acceleration sensor 403 makes it possible to periodically measure the acceleration applied onto the mobile telephone machine, and transmit the acceleration information including the measured acceleration to the history information server 440.

Further, the wireless LAN device 402 makes it possible to periodically transmit a contents acquisition request to the WEB server 460, receive the contents including the sales information of the neighboring shops and the like, and to display it on a screen.

The mobile telephone network 410 is a wireless/wire network that mobile telephone operator possess.

The wireless LAN base station 420 is installed in shops and facilities within the town, and each base station transmits an identification signal such as ESSID.

The data center 430 is possessed, for example, by the mobile telephone operator, is connected to the mobile telephone network 410, and has the history information server 440, the contents server 450, and the WEB server 460 installed in the inside thereof.

The history information server 440 is a server device.

The contents server 450, which is a server device, generates the contents including the sales information of the neighboring shops and the like based on the history information received from the history information server 440, and transmits the user identifier and the contents to the WEB server 460.

The WEB server 460, which is a server device, receives the user identifier and the contents from the contents server 450, and keeps them in the inside thereof. Further, the WEB server 460, upon receipt of a request for acquiring the contents including the user identifier from the user terminal 400, transmits the contents corresponding to the aforementioned user identifier to the user terminal 400.

Additionally, as apparent from the above-described explanation, each unit can be configured with hardware; however, it can be also realized with a computer program. In this case, functions and operations similar to those of the above-described embodiments are realized with a processor that operates under a program stored in a program memory.

Further, the content of the above-mentioned exemplary embodiments can be expressed as follows.

(Supplementary note 1) An information provision server, comprising:

a history information accumulation unit that accumulates a user identifier and history element information received from a terminal of a user as history information;

a rule storage unit that stores a rule of authorizing an output of the history information of the user accumulated in said history information accumulation unit to a service server that provides a service to said terminal;

a rule assessment unit that receives the user identifier and assessment element information from the terminal, assesses said assessment element information based on said rule, and lists the user identifier corresponding to said assessment element information in an output authorization list when said assessment element information meets said rule; and

a filtering unit that extracts the history information corresponding to the user identifier listed in said output authorization list from said history information accumulation unit in response to an output request for the history information by said service server, and outputs the extracted history information to said service server.

(Supplementary note 2) The information provision server according to Supplementary note 1, wherein when said assessment element information does not meet said rule and yet the user identifier corresponding to said assessment element information is listed in said output authorization list, said rule assessment unit deletes the above user identifier from said output authorization list.

(Supplementary note 3) The information provision server according to Supplementary note 1 or Supplementary note 2, wherein said rule includes at least an attribute name of an attribute of an assessment element and a range of attribute values of said attribute that can be allowed in a case of authorizing an output of the history information to the service server.

(Supplementary note 4) The information provision server according to Supplementary note 1 or Supplementary note 2:

wherein said rule includes at least an attribute name of the history information to be outputted to the service server, an attribute name of an attribute of an assessment element, and a range of attribute values of the attribute of said assessment element that can be allowed in a case of authorizing an output of the history information to the service server; and

wherein when the attribute name of the history element information received from the user terminal is the attribute name of the history information of said rule to be outputted to the service server, said rule assessment unit lists the user identifier corresponding to said received history element information in said output authorization list, and when the received assessment element information does not meet said rule and yet the user identifier corresponding to said assessment element information is listed in said output authorization list, said rule assessment unit deletes the above user identifier from said output authorization list.

(Supplementary note 5) The information provision server according to one of Supplementary note 1 to Supplementary note 4, wherein said rule is set for each service to be provided by the service server.

(Supplementary note 6) The information provision server according to one of Supplementary note 1 to Supplementary note 4, wherein said rule is set for each attribute of the history information to be provided to the service server.

(Supplementary note 7) The information provision server according to one of Supplementary note 1 to Supplementary note 4, wherein said rule is set for each user identifier.

(Supplementary note 8) The information provision server according to one of Supplementary note 1 to Supplementary note 7, wherein said assessment element information is position information.

(Supplementary note 9) An information provision system, comprising:

an information provision server comprising:
a history information accumulation unit that accumulates a user identifier and history element information received from a terminal as history information;
a rule storage unit that stores a rule of authorizing an output of the history information of a user accumulated in said history information accumulation unit to a service server that provides a service to said terminal;
a rule assessment unit that receives the user identifier and assessment element information from said terminal, assesses said assessment element information based on said rule, and lists the user identifier corresponding to said assessment element information in an output authorization list when said assessment element information meets said rule; and
a filtering unit that extracts the history information corresponding to the user identifier listed in said output authorization list from said history information accumulation unit in response to an output request for the history information by said service server, and outputs the extracted history information to said service server;

a terminal comprising:
an acquisition unit that acquires the history element information or the assessment element information of the terminal; and
an information transmission unit that transmits information including said user identifier and at least one of the acquired history element information and said assessment element information to said information provision server; and

a service server comprising:
a history request unit that requests said information provision server to output the history information; and
a service provision unit that provides the service to said terminal based on the history information coming from said information provision server.

(Supplementary note 10) The information provision system according to Supplementary note 9, wherein when said assessment element information does not meet said rule and yet the user identifier corresponding to said assessment element information is listed in said output authorization list, said rule assessment unit deletes the above user identifier from said output authorization list.

(Supplementary note 11) The information provision system according to Supplementary note 9 or Supplementary note 10, wherein said rule includes at least an attribute name of an attribute of an assessment element and an allowable range of attribute values of said attribute in which an output to the service server is authorized.

(Supplementary note 12) The information provision system according to Supplementary note 9 or Supplementary note 10:

wherein said rule includes at least an attribute name of the history information to be outputted to the service server, an attribute name of an attribute of an assessment element, and an allowable range of attribute values of the attribute of said assessment element in which an output to the service server is authorized; and

wherein when the attribute name of the history element information received from the user terminal is the attribute name of the history information of said rule to outputted to the service server, said rule assessment unit lists the user identifier corresponding to said received history element information in said output authorization list, and when the received assessment element information does not meet said rule and yet the user identifier corresponding to said assessment element information is listed in said output authorization list, said rule assessment unit deletes the above user identifier from said output authorization list.

(Supplementary note 13) An information provision method, comprising:

accumulating a user identifier and history element information received from a terminal of a user as history information;

assessing assessment element information received from said terminal based on a rule of authorizing an output of said accumulated history information of the user to a service server that provides a service to said terminal, and updating, in such a manner that the user identifier corresponding to said assessment element information is listed in an output authorization list that authorizes an output of the history information to said service server, said output authorization list when said assessment element information meets said rule; and

extracting the history information corresponding to the user identifier listed in said output authorization list from said accumulated history information of the user in response to an output request for the history information by said service server and outputting the extracted history information to said service server.

(Supplementary note 14) The information provision method according to Supplementary note 13, wherein said output authorization list is updated in such a manner that when said assessment element information meets said rule, the user identifier corresponding to said assessment element information is listed in said output authorization list, and when said assessment element information does not meet said rule and yet the user identifier corresponding to said assessment element information is listed in said output authorization list, the above user identifier is deleted from said output authorization list.

(Supplementary note 15) The information provision method according to Supplementary note 13or Supplementary note 14, wherein said rule includes at least an attribute name of an attribute of an assessment element and an allowable range of attribute values of said attribute in which an output to the service server is authorized.

(Supplementary note 16) The information provision method according to Supplementary note 13or Supplementary note 14:

wherein said rule includes at least an attribute name of the history information to be outputted to the service server, an attribute name of an attribute of an assessment element, and a range of attribute values of the attribute of said assessment element that can be allowed in a case of authorizing an output of the history information to the service server; and

wherein said output authorization list is updated in such a manner that when the attribute name of the history element information received from the terminal of the user is the attribute name of the history information of said rule to be outputted to the service server, the user identifier corresponding to said received history element information is listed in said output authorization list, and when the received assessment element information does not meet said rule and yet the user identifier corresponding to said assessment element information is listed in said output authorization list, the above user identifier is deleted from said output authorization list.

(Supplementary note 17) A program for causing an information processing device to execute the processes of:

accumulating a user identifier and history element information received from a terminal of a user as history information;

assessing assessment element information received from said terminal based on a rule of authorizing an output of said accumulated history information of the user to a service server that provides a service to said terminal, and updating, in such a manner that the user identifier corresponding to said assessment element information is listed in an output authorization list that authorizes an output of the history information to said service server, said output authorization list when said assessment element information meets said rule; and

extracting the history information corresponding to the user identifier listed in said output authorization list from said accumulated history information of the user in response to an output request for the history information by said service server and outputting the extracted history information to said service server.

This application is based upon and claims the benefit of priority from Japanese patent application No. 2010-224290, filed on Oct. 1, 2010 the disclosure of which is incorporated herein in its entirety by reference.

### INDUSTRIAL APPLICABILITY

The present invention has applicability in various applications such as the advertisement, the contents delivery, and the security setting in linkage to the past history information of the user.

### REFERENCE SIGNS LIST

1 management server
2 user terminal
3 service server
11 user information reception unit
12 rule assessment unit
13 filtering unit
14 history information storage unit
15 rule storage unit
16 authorization list storage unit

What is claimed is:

1: An information provision server, comprising:
a history information accumulation unit that accumulates a user identifier and history element information received from a terminal of a user as history information;
a rule storage unit that stores a rule of authorizing an output of the history information of the user accumulated in said history information accumulation unit to a service server that provides a service to said terminal;
a rule assessment unit that receives the user identifier and assessment element information from the terminal, assesses said assessment element information based on said rule, and lists the user identifier corresponding to said assessment element information in an output authorization list when said assessment element information meets said rule; and
a filtering unit that extracts the history information corresponding to the user identifier listed in said output authorization list from said history information accumulation unit in response to an output request for the history information by said service server, and outputs the extracted history information to said service server.

2: The information provision server according to claim 1, wherein when said assessment element information does not meet said rule and yet the user identifier corresponding to said assessment element information is listed in said output authorization list, said rule assessment unit deletes the above user identifier from said output authorization list.

3: The information provision server according to claim 1, wherein said rule includes at least an attribute name of an attribute of an assessment element and a range of attribute values of said attribute that can be allowed in a case of authorizing an output of the history information to the service server.

4: The information provision server according to claim 1:
wherein said rule includes at least an attribute name of the history information to be outputted to the service server, an attribute name of an attribute of an assessment element, and a range of attribute values of the attribute of said assessment element that can be allowed in a case of authorizing an output of the history information to the service server; and
wherein when the attribute name of the history element information received from the user terminal is the attribute name of the history information of said rule to be outputted to the service server, said rule assessment unit lists the user identifier corresponding to said received history element information in said output authorization list, and when the received assessment element information does not meet said rule and yet the user identifier corresponding to said assessment element information is listed in said output authorization list, said rule assessment unit deletes the above user identifier from said output authorization list.

5: The information provision server according to claim 1, wherein said rule is set for each service to be provided by the service server.

6: The information provision server according to claim 1, wherein said rule is set for each attribute of the history information to be provided to the service server.

7: The information provision server according to claim 1, wherein said rule is set for each user identifier.

8: The information provision server according to claim 1, wherein said assessment element information is position information.

9: An information provision system, comprising:
an information provision server comprising:
a history information accumulation unit that accumulates a user identifier and history element information received from a terminal as history information;
a rule storage unit that stores a rule of authorizing an output of the history information of a user accumulated in said history information accumulation unit to a service server that provides a service to said terminal;
a rule assessment unit that receives the user identifier and assessment element information from said terminal, assesses said assessment element information based on said rule, and lists the user identifier corresponding to said assessment element information in an output authorization list when said assessment element information meets said rule; and
a filtering unit that extracts the history information corresponding to the user identifier listed in said output authorization list from said history information accumulation unit in response to an output request for the history information by said service server, and outputs the extracted history information to said service server;
a terminal comprising:
an acquisition unit that acquires the history element information or the assessment element information of the terminal; and
an information transmission unit that transmits information including said user identifier and at least one of the acquired history element information and said assessment element information to said information provision server; and
a service server comprising:
a history request unit that requests said information provision server to output the history information; and
a service provision unit that provides the service to said terminal based on the history information coming from said information provision server.

10: The information provision system according to claim 9, wherein when said assessment element information does not meet said rule and yet the user identifier corresponding to said assessment element information is listed in said output authorization list, said rule assessment unit deletes the above user identifier from said output authorization list.

11: The information provision system according to claim 9, wherein said rule includes at least an attribute name of an attribute of an assessment element and an allowable range of attribute values of said attribute in which an output to the service server is authorized.

12: The information provision system according to claim 9:
wherein said rule includes at least an attribute name of the history information to be outputted to the service server, an attribute name of an attribute of an assessment element, and an allowable range of attribute values of the attribute of said assessment element in which an output to the service server is authorized; and
wherein when the attribute name of the history element information received from the user terminal is the attribute name of the history information of said rule to outputted to the service server, said rule assessment unit lists the user identifier corresponding to said received history element information in said output authorization list, and when the received assessment element information does not meet said rule and yet the user identifier corresponding to said assessment element information is listed in said output authorization list, said rule assessment unit deletes the above user identifier from said output authorization list.

13: An information provision method, comprising:
accumulating a user identifier and history element information received from a terminal of a user as history information;
assessing assessment element information received from said terminal based on a rule of authorizing an output of said accumulated history information of the user to a service server that provides a service to said terminal, and updating, in such a manner that the user identifier corresponding to said assessment element information is listed in an output authorization list that authorizes an output of the history information to said service server, said output authorization list when said assessment element information meets said rule; and
extracting the history information corresponding to the user identifier listed in said output authorization list from said accumulated history information of the user in response to an output request for the history information by said service server and outputting the extracted history information to said service server.

14: The information provision method according to claim 13, wherein said output authorization list is updated in such a manner that when said assessment element information meets said rule, the user identifier corresponding to said assessment element information is listed in said output authorization list, and when said assessment element information does not meet said rule and yet the user identifier corresponding to said assessment element information is listed in said output authorization list, the above user identifier is deleted from said output authorization list.

15: The information provision method according to claim 13, wherein said rule includes at least an attribute name of an attribute of an assessment element and an allowable range of attribute values of said attribute in which an output to the service server is authorized.

16: The information provision method according to claim 13:
wherein said rule includes at least an attribute name of the history information to be outputted to the service server, an attribute name of an attribute of an assessment element, and a range of attribute values of the attribute of said assessment element that can be allowed in a case of authorizing an output of the history information to the service server; and
wherein said output authorization list is updated in such a manner that when the attribute name of the history element information received from the terminal of the user is the attribute name of the history information of said rule to be outputted to the service server, the user identifier corresponding to said received history element information is listed in said output authorization list, and when the received assessment element information does not meet said rule and yet the user identifier corresponding to said assessment element information is listed in said output authorization list, the above user identifier is deleted from said output authorization list.

17: A non-transitory computer readable storage medium storing a program for causing an information processing device to execute the processes of:
accumulating a user identifier and history element information received from a terminal of a user as history information;
assessing assessment element information received from said terminal based on a rule of authorizing an output of said accumulated history information of the user to a service server that provides a service to said terminal, and updating, in such a manner that the user identifier corresponding to said assessment element information is listed in an output authorization list that authorizes an output of the history information to said service server, said output authorization list when said assessment element information meets said rule; and
extracting the history information corresponding to the user identifier listed in said output authorization list from said accumulated history information of the user in response to an output request for the history information by said service server and outputting the extracted history information to said service server.
